(19) United States
(12) Patent Application Publication
(10) Pub. No.: US 2021/0320438 A1
(43) Pub. Date: Oct. 14, 2021

(54) CONNECTION DEVICE FOR THE CONNECTION OF A CONDUCTOR END

(71) Applicant: Weidmüller Interface GmbH & Co. KG, Detmold (DE)

(72) Inventors: Karlo STJEPANOVIC, Bielefeld (DE); Stephan FEHLING, Lage (DE); Stefan FISCHER, Detmold (DE); Frank HACKEMACK, Detmold (DE); Andreas RUTZ, Bielefeld (DE); Jörg MÜNSTERMANN, Schlangen (DE); Marco WALDHOFF, Steinheim (DE)

(21) Appl. No.: 16/767,292

(22) PCT Filed: Nov. 21, 2018
(86) PCT No.: PCT/EP2018/082075

§ 371 Date: Oct. 22, 2020

(30) Foreign Application Priority Data
Nov. 28, 2017 (DE) 20 2017 107 209.6

(51) Int. Cl. H01R 4/48; H01R 11/09

(52) U.S. Cl. CPC H01R 4/4836; H01R 11/09

(57) ABSTRACT

A connection device for the connection of a conductor end includes a housing, a busbar section arranged in the housing, and a clamping spring assembly rotatably connected with the housing and operable between an open position and a contact position in contact with the conductor end. A rotary lever assembly is operably connected with the clamping spring assembly. The clamping spring assembly includes at least one clamping spring having clamping and actuating limbs arranged at an acute angle and connected by a bending region bearing against a spring carrier. The clamping spring assembly is preferably preassembled on the spring carrier for insertion in the housing.

The invention relates to a connection device for the connection of a conductor end in accordance with the preamble of claim 1.

Connection devices of this type are known in the art. However, with regard to the handling and structural design of the known connection devices, they are only able to be actuated with difficulty, specifically when contacting conductors of larger diameter, and therefore require improvement.

Against this background, the object of the invention is to provide a connection device which is improved in terms of the handling and structural design thereof.

The invention achieves this object by way of the subject matter of claim 1.

The invention provides a connection device for the connection of a conductor end, which connection device has a housing and also a busbar section, a clamping spring arrangement and a rotary lever arrangement in the housing, the clamping spring arrangement being able to be rotated, with the aid of the rotary lever arrangement, from an open position to a contact position in which contact is made with the conductor end, the clamping spring arrangement consisting of one or more clamping springs which are each embodied as leaf springs and each have at least one clamping limb and at least one actuating limb.

The at least one clamping limb and the at least one actuating limb are oriented at an angle, preferably at an acute angle of between 5° and 85°, in relation to one another and are connected to one another by means of a bending region, the bending region of at least one of the leaf springs bearing against a spring carrier. This construction is further distinguished in that the spring carrier is designed as a part which is preferably separate from the housing, and in that the clamping spring arrangement can be preassembled on the spring carrier. As a result of this measure, the arrangement and mounting of the springs can be greatly facilitated.

In accordance with one measure which further optimises mounting, it may be provided that the preassembled unit can be inserted into the housing individually and separately or together with another element, in particular together with the busbar section.

In this context, in an alternative variant, it may be provided that the preassembled unit can be fixed in the housing or on the associated busbar section, for example in a positive and/or non-positive fit, in particular by clamping and/or latching.

To simplify mounting the clamping springs, it may be provided that the spring carrier has one or more mounting means, in particular one or more slots, for mounting the one or more clamping springs.

In another advantageous development, it may be provided that the spring carrier is arranged pivotably in the housing. It can then itself take on part of the spring functionality, in particular the functionality of the actuating limb or of an extension of the actuating limb.

It may also be provided that the spring carrier has one or more mounting means, in particular one or more slots, for mounting a restoring spring, so as also to be able to integrate this functionality into the spring carrier in a simple manner. In this context, it may advantageously be provided that the restoring spring is formed as a further leaf spring.

In one development, a means of the cam section, such as a projection or such as a pin or the like inserted into said section, engages in a slotted link of the housing, and a clamping and/or latching means is formed on the cam section and is movable in the slotted link into a fixing position, the fixing position being formed in the busbar section. In this way, both reliable contacting of a conductor and reliable release of the conductor from the end contact position can take place in a simple manner.

It is particularly advantageous if the end contact position is durably securely fixed on the metal busbar and not in the plastics material housing. In this context, attaching a pin to the cam section and forming the latching position in the slotted link of the busbar section provides a particularly simple variant for implementing the fixing of the spring arrangement in the end contact position, which also results in simple and consistent usability when establishing and releasing the contact position.

It may advantageously be provided that the clamping and/or latching means is a pin, in particular a metal pin, which is movable in the slotted link into a fixing position.

It may further advantageously be provided that in the housing, before the latching position is reached, the slotted link transitions into a corresponding slotted link in the associated busbar section or rather ends in this section, and that this slotted link has a point, in particular a constriction point or a top-dead-centre point, at which the pin is fixed securely in position when the end contact position is reached, in such a way that the end contact position is durably securely fixed at the metal busbar section. Specifically for releasing the end contact position, it is merely necessary to move the pin out of the latching position behind the constriction point in the slotted link by rotating the rotary lever arrangement.

In this way, when the end contact position is reached, the clamping limb or limbs press on the conductor end, the clamping spring arrangement and/or the rotary lever arrangement additionally being locked on a thrust bearing in a positive and/or non-positive fit by means of a locking device.

In an embodiment which is preferred but which is not compulsory in the present specification, the rotary lever arrangement and the clamping spring arrangement may—always or at least during the rotation from the open position into the contact position—have the same direction of rotation. However, it is also possible for them to have opposite directions of rotation. If they have identical directions of rotation, this has the advantage that the actuating force for switching remains low in spite of a high force on the clamping spring arrangement. As a result of the increasingly large lever, the torque increases for the same actuating force.

To achieve more favourable actuating forces, preferably high contact forces and a compact, narrow design, it may advantageously be provided that the axis of rotation D1 of the clamping spring arrangement and sections of the clamping spring arrangement are arranged above the conductor end to be contacted and above the associated busbar section, and that the rotary lever arrangement has an axis of rotation D2 which is positioned above the axis of rotation D1 of the clamping spring arrangement.

In a further preferred variant, the busbar section may be configured trough-shaped, in particular V- or U-shaped, in cross section, the conductor end being insertable into the busbar section perpendicular to this cross section, and the clamping spring arrangement being designed to be pivoted, at least in sections, into the busbar section transverse to the conductor insertion direction so as to press the conductor end in the end contact position into the trough-shaped busbar section so as to contact said section. The invention is particularly well-suited to a structural configuration of this type.

It may further advantageously be provided that the rotary lever arrangement has a rotary lever element which is mounted rotatably in the housing in or on a preferably central section, and has the axis of rotation and that in this case the rotary lever element preferably has a cam section, which has—preferably on the face thereof facing the clamping spring arrangement—a control curve on which the actuating limb or limbs of the clamping springs slide along during a movement into the end contact position. The arrangement and the lever ratios thereof can be adjusted well for any angle of rotation and can thus be optimally adapted to the force requirement.

To ensure a well-guided movement into and out of the end contact position, it may be provided that a projection of the cam section or a pin or the like inserted into said section engages in a slotted link of the housing, specifically in an arc-shaped slotted link.

To secure the end contact position, it may be provided that, in the end contact position, the clamping spring arrangement and/or the actuating limb are additionally fixed, by means of a locking device, in a positive and/or non-positive fit, for example on the busbar section or on another element.

For this purpose, a clamping and/or latching means, for example the aforementioned pin which is movable into a fixing position in the slotted link, may be formed on the cam section, it being advantageous for the fixing position to be formed in the—preferably metal—busbar section, since in this way a high contact force can also be durably ensured.

It may further advantageously be provided that the actuating limb or limbs are formed elbowed at the free ends thereof so as to slide on the control curve.

However, the spring carrier may also—if an actuating limb is arranged rotationally engaged thereon—join in with the functionality of this actuating limb in whole or in part. In this case, said carrier also forms part of the clamping spring arrangement within the meaning of the claims.

Advantageous embodiments of the invention may be derived from the dependent claims. In the following, the invention is described in greater detail by way of embodiments with reference to the drawings, with further advantageous variants and configurations also being discussed. It should be emphasised that the embodiment discussed in the following is not intended to describe the invention conclusively, and that variants and equivalents which are not shown also fall within the claims. In the drawings:

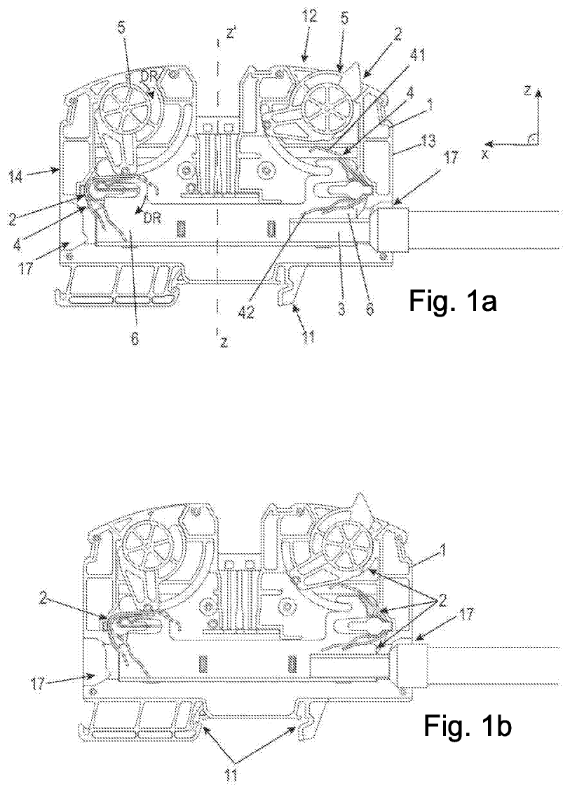

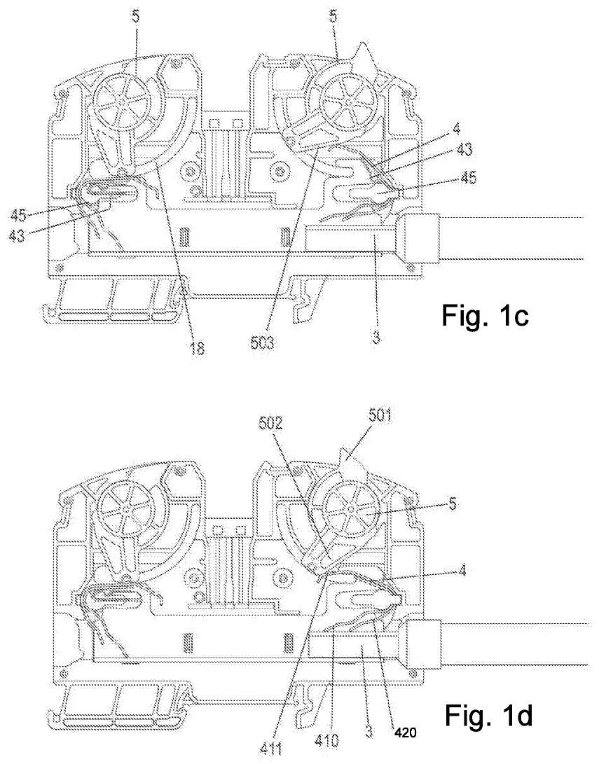

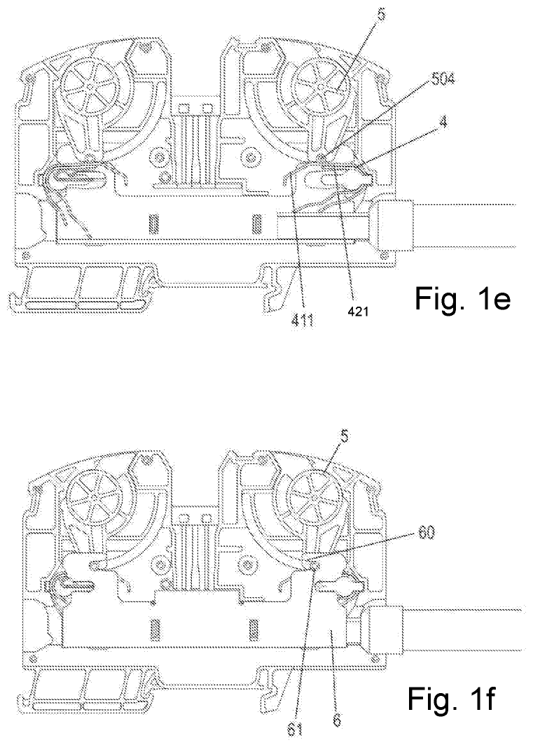

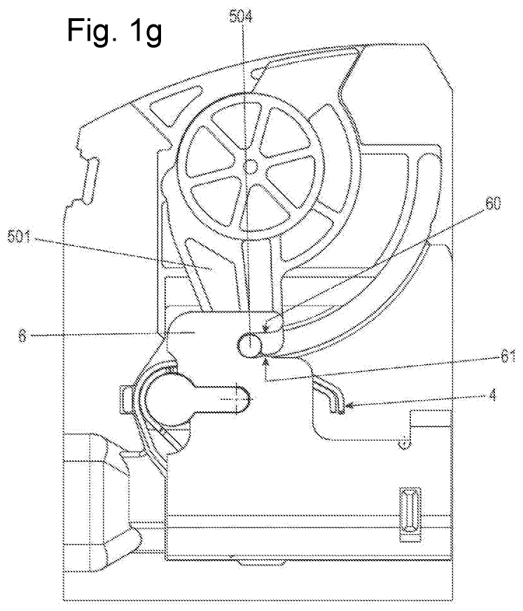

FIG. 1 a) shows a sectional view of a series terminal comprising connection devices according to the invention, of which one is in a first, closed operating position, without a conductor end inserted into it, and of which the other, second connection device is in an open, first operating position upon insertion of the conductor end; b) to e) show the series terminal of FIG. 1, the second connection device in each case being or having been moved, in temporally successive steps, into a contact position which is reached in FIG. 1 e); and f) shows a side view of the series terminal in the operating position of e), without a side wall that is optionally further attached/formed on the side; and g) shows an enlarged detail of a series terminal formed substantially in accordance with FIG. 1 f);

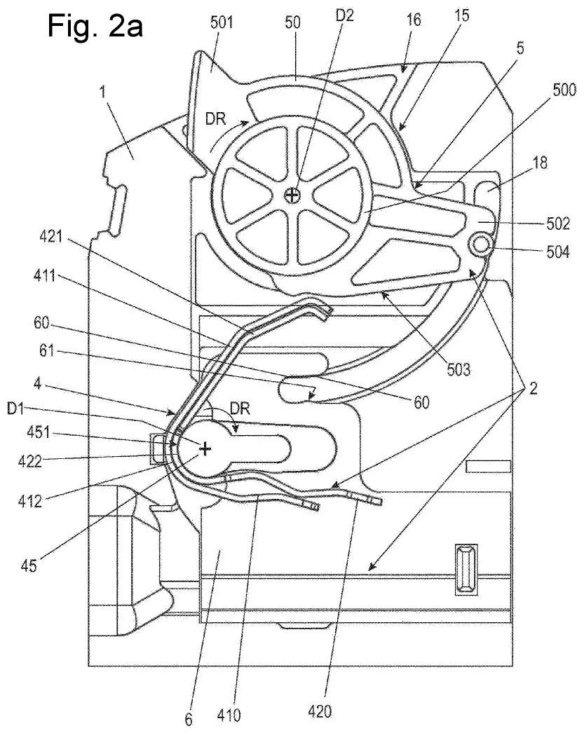

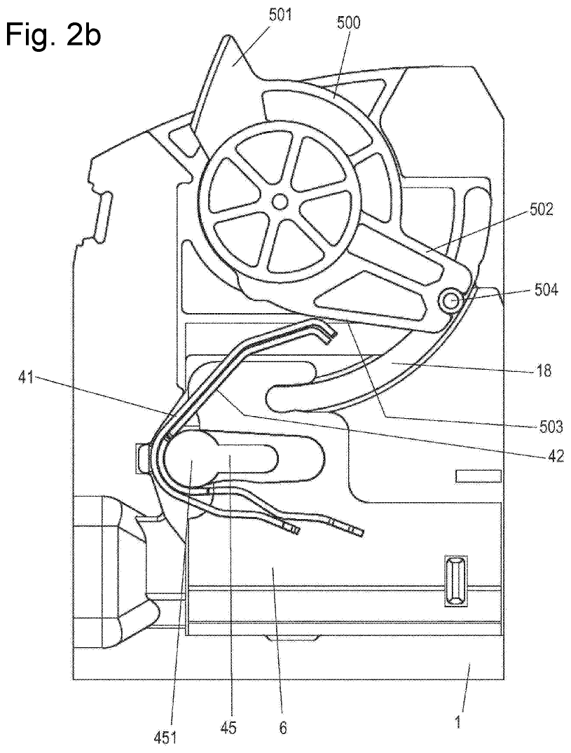

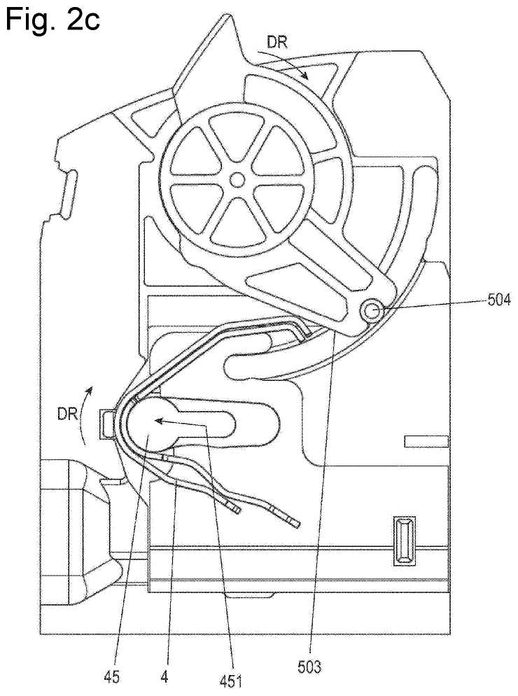

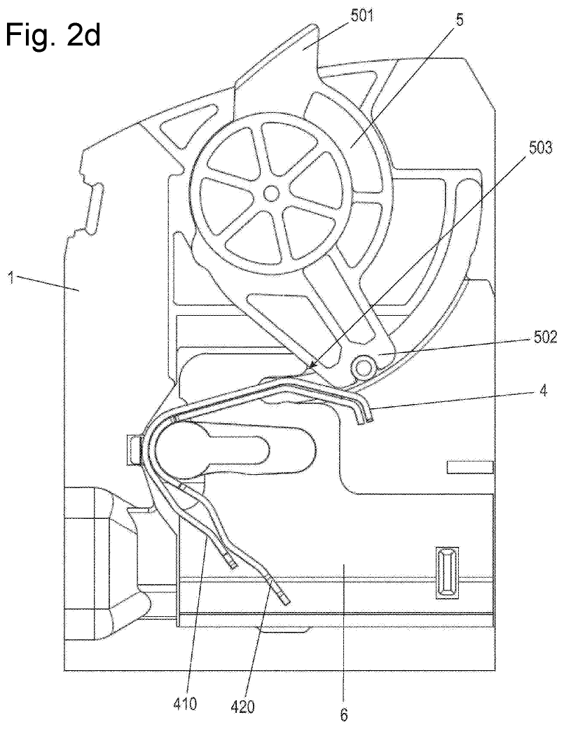

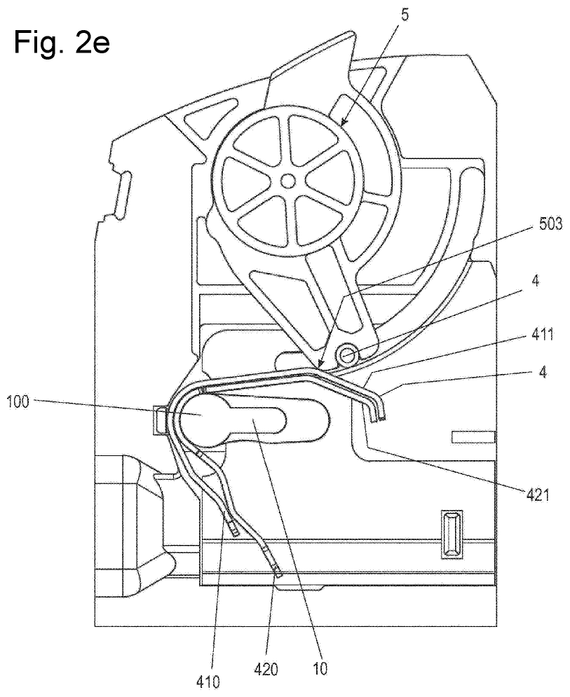

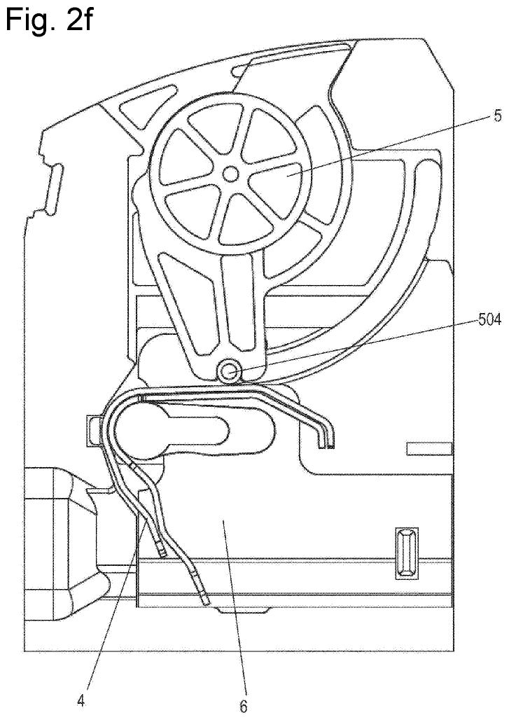

FIG. 2 a) to f) show a detail of the view of FIG. 1 a) with the first connection device in various operating positions, in which it is moved from an open position into a contact position—without a conductor—from a) to e);

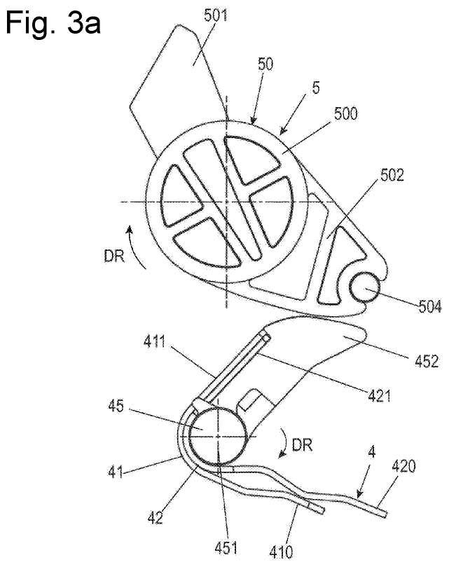

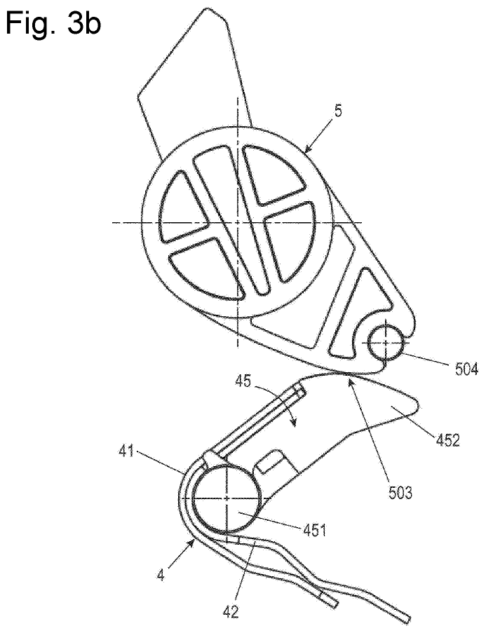

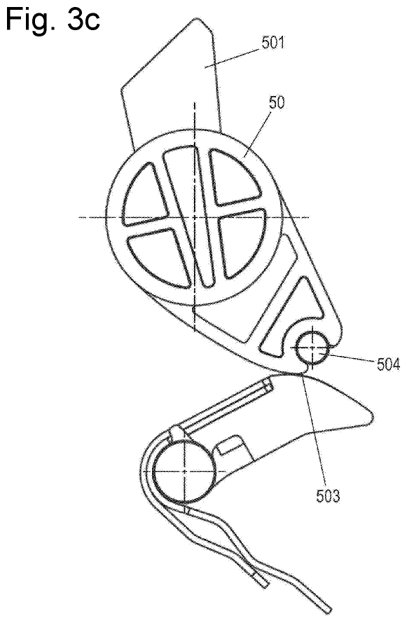

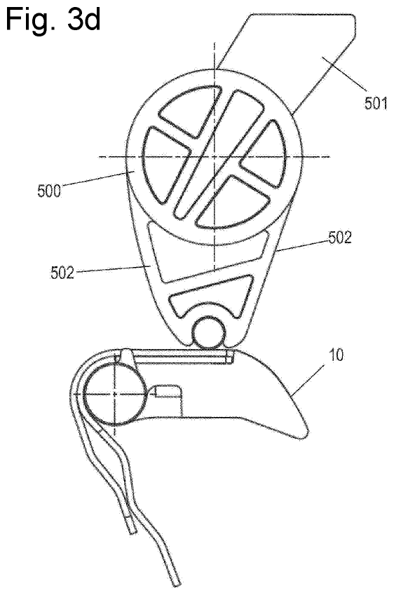

FIG. 3 a) to d) show movable elements of a variant of the connection device of FIG. 2 in various operating positions, in which the connection device is moved from an open position into a contact position—without a conductor—from a) to d);

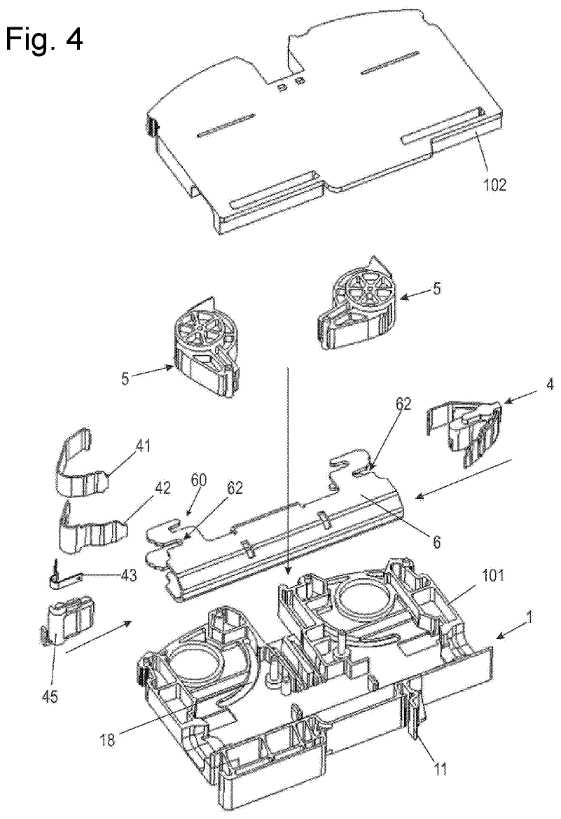

FIG. 4 shows an exploded view of a series terminal in the manner of FIG. 1;

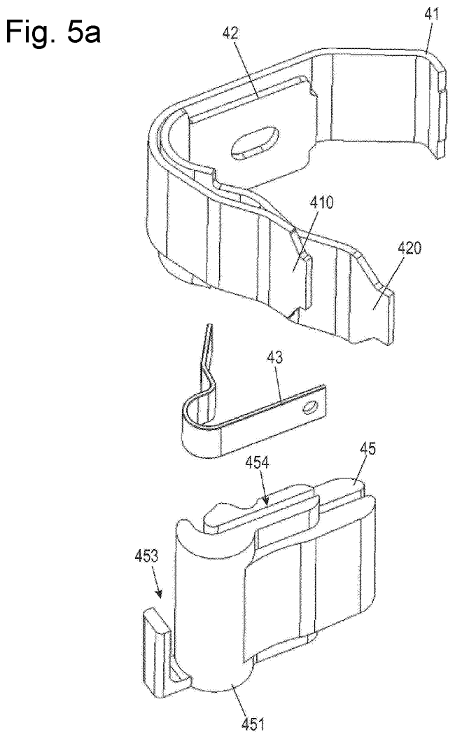

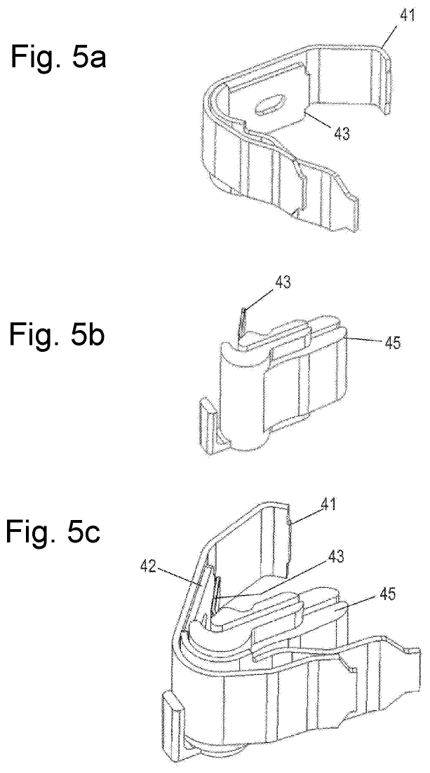

FIG. 5 a) shows an exploded view of a clamping spring arrangement for a series terminal in the manner of FIG. 1; and a) to c) additionally show successive mounting steps during the mounting of leaf springs, such as are used for example in the series terminal of FIG. 1, on the clamping spring arrangement;

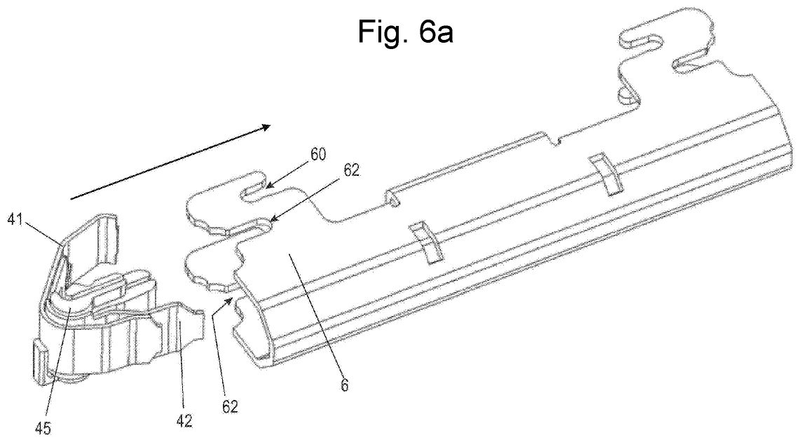

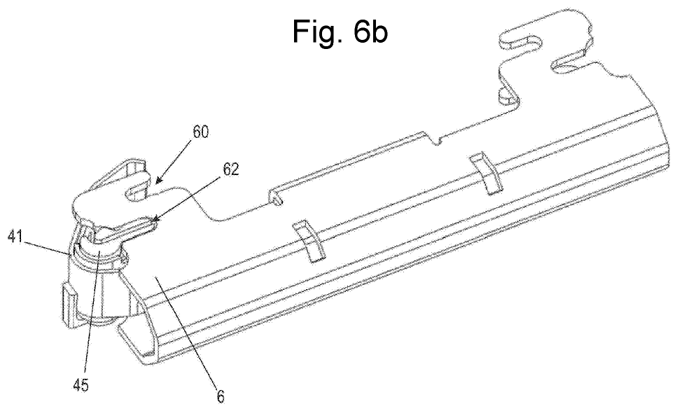

FIG. 6 a) and b) show successive mounting steps during mounting of the clamping spring arrangement of FIG. 5 on a busbar such as is used for example in the series terminal of FIG. 1;

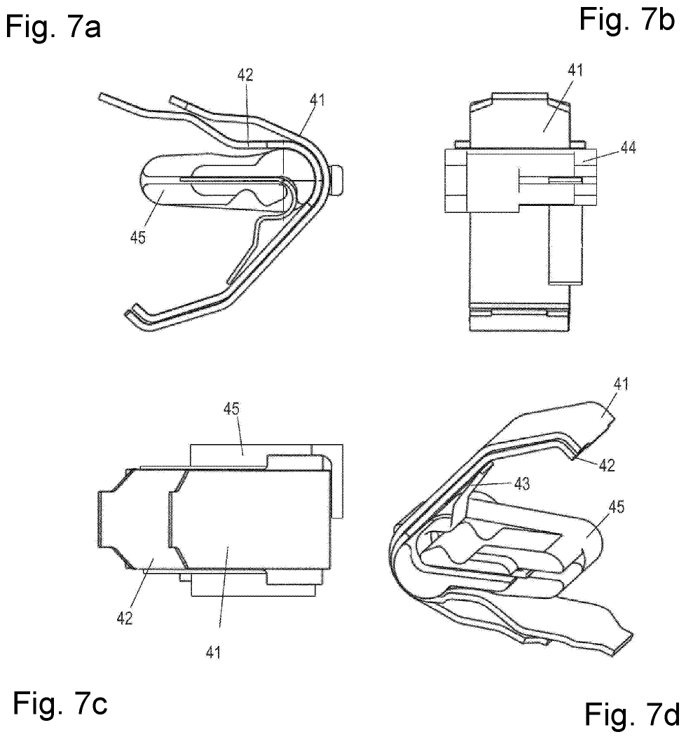

FIG. 7 a) to d) show different views of a first variant of a clamping spring arrangement such as is used for example in the series terminal of FIG. 1; and

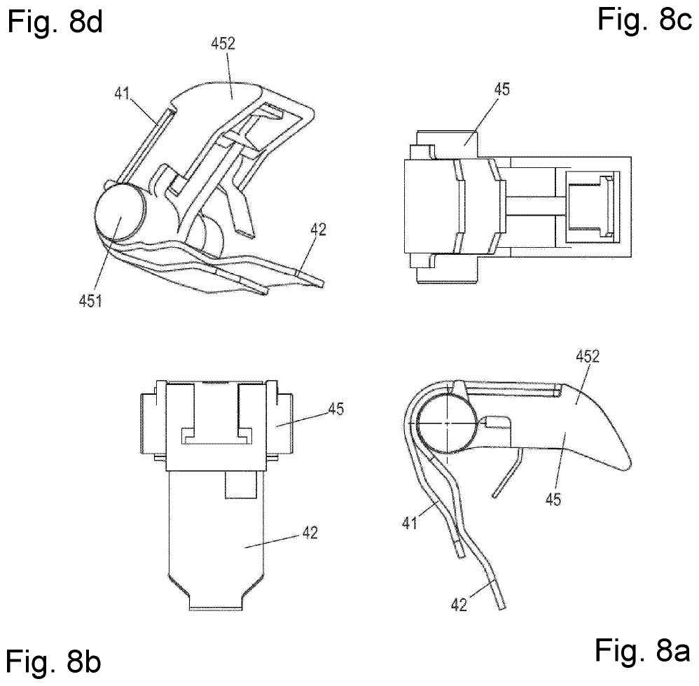

FIG. 8 a) to d) show different views of a second variant of a clamping spring arrangement such as is used for example in the series terminal of FIG. 3.

For simplicity, a Cartesian coordinate system X/Z is illustrated in FIG. 1, the direction perpendicular to the plane of the page being designated as the Y-direction. In the following, the conductor insertion direction is designated as the X-direction.

FIG. 1 shows a housing 1, which in this case is formed as a terminal housing. One or more—in this case two—connection devices 2 for connecting an associated conductor end 3 are arranged in the housing. In FIG. 1, only one of these conductor ends 3 is shown. The conductor ends 3 may be (preferably insulation-stripped) single wires or multiple or stranded conductors or for example crimped wire ends of a highly electrically conductive material, such as copper.

The housing 1 consists of electrically insulating material, in particular of a non-conductive plastics material. The housing 1 is formed disc-shaped in this case, and is preferably configured to be stackable in the Y-direction perpendicular to the conductor insertion direction. The terms right, left, up and down are based on the portrayal in the drawings, and accordingly change when the housing 1 moves in space.

The housing 1 may have an affixing foot 11. In this case, said foot is formed for placement, in particular latching, on a carrier rail (not shown, for example hat-shaped in cross section). The housing 1 further has an upper face 12 (this being the face remote from the affixing foot 11) and two plug-in faces 13, 14. In an (imaginary) coordinate system, the direction perpendicular to the plane of the drawing is designated as the Y-direction (the carrier rail extending in this direction), the direction perpendicular to the carrier rail (in FIG. 1 the vertically upward direction) as the Z-direction, and the direction perpendicular thereto (leftwards in FIG. 1) as the X-direction. The two conductor ends 3 are movable in and counter to the X-direction. Thus, the conductor insertion direction of the right conductor end 3 into the right connection device 2 is the X-direction and the conductor insertion direction of the left conductor end (not shown here) into the left connection device 2 is the −X-direction.

The connection devices 2 may be formed identically or be symmetrical with respect to one another, in other words mirror-symmetrical about the imaginary plane z-z′ perpendicular to the plane of the drawing. As a result, two conductor ends 3 can be inserted into the housing 1, well and in a simple manner, from opposite sides and can be contacted therein by the associated connection device 2. This has for example advantageously been implemented in the embodiment of FIG. 1-3. One, two as shown, or even more of the connection devices may be arranged in a housing, and thus side by side (for example in a multi-part housing 1).

The connection devices 2 each have a clamping spring arrangement 4 and a rotary lever arrangement 5. In addition, they each have a busbar section 6 against which the associated conductor end can be pressed or pushed by means of the clamping spring arrangement. The clamping spring arrangement 4 acts in the manner of a compression spring in each case.

In FIG. 1, the busbar sections 6 are configured in a single piece with one another, in such a way that the two connection devices 2 are conductively connected by an in this case single-piece busbar. In this way, a through-terminal is implemented between the two connection devices without an electrical functional module. It would also be conceivable to form the two busbar sections 6 as separate busbars which are conductively interconnected directly or via at least one electrical or electronic component.

The busbar sections 6 preferably have a V or U shape in cross section (see also FIG. 1f). The primary extension direction of the busbar sections 6 is the X-direction perpendicular to this V or U cross section. The associated conductor end 3 is inserted into the connection devices 2 parallel to this primary extension direction (+X, −X) in each case. For this purpose, in the extension of the associated busbar section 6, each housing 1 has an insertion opening 17 for the conductor. The V or U shape may extend over the entire length of the busbar arrangement in the primary extension direction or else over part of the length.

The clamping spring arrangement 4 is embodied in such a way that, for introducing the associated conductor end 3, it is pivotable out of the busbar section 6 in such a way that a conductor end 3 is insertable into the associated busbar section 6 through the insertion opening 17. To contact the conductor, the clamping spring arrangement 4 as a whole is pivoted towards and partially into the busbar section 6, with the conductor end 3 being contacted. The clamping spring arrangement 4 finally takes on a fixed position in the contact position and presses the conductor end 3 against the associated busbar section 6 made of electrically highly conductive material, in such a way that at least one contact point through which an electric current can flow is formed.

The clamping spring arrangement 4 consists of one or more clamping springs 41, 42 (for which see also FIGS. 2a and 3a), which are embodied as leaf springs. In FIG. 1, two leaf springs are provided, and serve to generate a sufficient contact force. These leaf springs each have at least one clamping limb 410, 420 and at least one actuating limb 411, 421. The at least one clamping limb 410, 420 and the at least one actuating limb 411, 421 are angled, preferably acute-angled at an angle of between 5° and 85° to one another. They are further preferably each interconnected via a bending region 412, 422 or a sort of radius. The bending region 412, 422 is preferably positioned on a spring carrier 45. In FIGS. 2 and 3, the conductor end is not shown in each case, so as better to illustrate the rotational movement of the clamping spring arrangement 4, which otherwise is influenced by the action of the clamping limb 3 on the conductor end 3.

In addition, there is a further leaf spring 43, which is a restoring spring.

The spring carrier 45 may be formed in a single piece with the housing 1 or as a separate part from the housing. If it is formed separately from the housing 1, it is advantageous for the clamping spring arrangement 4 to be capable of being preassembled on the spring carrier 45, and for the preassembled unit subsequently to be insertable into the housing 1 separately and fixable therein, for example in a positive and/or non-positive fit, in particular by clamping and/or latching.

The spring carrier 45 may also be arranged pivotably in the housing. In this case, it may even—if the actuating limb is arranged rotationally engaged thereon—join in with the functionality of this actuating limb 410 in whole or in part. This functionality is shown in FIG. 3. In this case, said carrier forms part of the clamping spring arrangement 4 within the meaning of the claims.

The clamping springs 41, 42 of the leaf spring arrangement are preferably arranged laid inside one another in a stack-like manner. This means that the bending regions 412, 422 thereof are positioned inside one another and have exactly or substantially the same axis of rotation D1 or D1′. In this case, the support contour has a rounded journal section 451, about which the clamping springs 41, 42 can be rotated in the bending regions 411, 412 thereof. In this case the spring carrier 45 serves, in the manner of a bolt, in the region in which the bending region 412, 422 is positioned against it, as a pivot bearing for the clamping spring arrangement or for the one or more individual springs or clamping springs of the clamping spring arrangement 4.

The spring carrier 45 may have one or more slots 453, 454 (see FIG. 5) in which one or more of the springs 41, 42 and 43 are respectively insertable and capable of being preassembled. In this way, these springs 41, 42, 43 and the spring carrier 45 can form a preassembled unit, which is preassembled as a whole and subsequently undergoes further mounting.

A development of this variant provides that the busbar 6 has, at both ends or at each busbar section 6, a slot 62 (in the two limbs of the busbar of U- or V-shaped cross section) into which the spring carrier 45 is insertable. In this case, the busbar 6 can in turn form, with the preassembled clamping spring arrangement or arrangements 4, a preassembled unit which is preassembled as a whole and inserted into the clamping housing 1 (see FIGS. 4 and 6). This further simplifies the mounting.

Preferably, the actuating limbs 411, 421 and/or the clamping limbs 410, 420 of the leaf springs 41, 42 are of different lengths. If the actuating limbs 411, 421 are of different lengths, this makes it possible to contact conductor ends 3 of different diameters very well, at positions respectively well-suited thereto, in a simple manner. It is also conceivable to contact a single conductor end 3 using two or more leaf springs at different points.

The clamping spring arrangement 4 is preferably orientated in such a way that the bending region 412, 422 is closest to the associated conductor insertion opening 17, in such a way that the clamping limb 410, 420, proceeding from the bending region 412, 422, extends away from the conductor insertion opening 17. The associated clamping limb 410, 420 and the associated actuating limb 411, 421 are thus preferably positioned at an acute angle to the conductor insertion direction (X-direction).

The axes of rotation D1 of the clamping spring arrangement(s) 4 and sections of the clamping spring arrangement 4 are positioned in the region of the support contour, or the support contour is positioned above the conductor end 3 to be contacted and above the associated busbar section 6 in the Z-direction—in other words in this case perpendicular to the affixing foot or to the carrier rail. The associated rotary lever arrangement 5, which has an axis of rotation D2, is further arranged above the clamping spring arrangement 4 in the Z-direction. The axis of rotation D2 is positioned above the axis of rotation D1 of the clamping spring arrangement in the Z-direction.

Overall, an arrangement is produced in such a way that in the housing 1, for each connection device 2, the busbar arrangement 6 is arranged below and the open face of the V- or U-shaped cross section thereof is directed towards the associated clamping spring arrangement 4, in such a way that the clamping limb or limbs 410, 420 are pivotable into the busbar arrangement. In addition, the axis of rotation D2 of the rotary lever arrangement 5 is formed and arranged above the clamping spring arrangement 4. In this context, the directions of rotation DR of the rotary lever arrangement 5 and DR of the clamping spring arrangement 4 are in the same direction or orientation. Thus, in the left connection device of FIG. 1 they each rotate clockwise for contacting, and in the right connection device 2 of FIG. 1 they each rotate anticlockwise for contacting. For release, they are each rotated in the reverse direction. This advantageous functionality is to be explained in greater detail in the following.

Using the rotary lever arrangement 5, the clamping spring arrangement 4 can be pivoted from an open position (FIG. 1a) (via the plurality of intermediate steps of FIG. 1b to id, FIG. 2a to 2e, FIG. 3a to 3e) into a contact position (FIG. 1e, 2e, 3d). The rotary lever arrangement 5 has a cam-like shaping. The rotary lever arrangement 5 has a preferably disc-like rotary lever element 50, which is mounted rotatably in the housing 1 in or on a preferably central section 500 and has the axis of rotation D2. This can be implemented in various ways. For example, the rotary lever element 50 may be placed on or passed through by a journal in the housing 1, and/or may be inserted into a rotary receiving contour 15 of the housing 1—a recess—which in any case encloses it in sections on the outer periphery.

The rotary lever element 50 has an actuating section 501, which is preferably accessible from outside the housing 1, in particular at an opening 16 on the upper face 12 of the housing 1. The actuating section 501 may for example be formed as a shoulder protruding radially from the central section 500 or as an opening, in the region 500, which makes it possible to apply a tool, in particular a screwdriver or the like. Said section may also serve as a stop for delimiting the angle of rotation, in and/or counter to the direction of rotation, in cooperation with an opening 16 of the housing from which it projects (see FIG. 2a in each case).

The rotary lever element 50 further has a cam section 502. In the present case, the cam section 502 is configured as a sort of arm, which extends radially outwards, eccentrically, in the present case substantially tangentially, with respect to the central section 500.

The cam section 502 has, on the face thereof facing the clamping spring arrangement 4, a sort of control curve 503, against which the actuating limb or limbs 411, 412 of the clamping springs 41, 42 can be brought to bear.

A projection of the cam section 502 or a pin 504 or the like inserted into said section may engage in a slotted link, in particular an arc-shaped slotted link 18, of the housing 1, providing a particularly secure and uniform opening movement.

In the completely open state, the cam section 502 may be positioned on the actuating limbs 411. However, this is not a compulsory requirement (FIG. 2a). Rather, it is also conceivable for said section to be positioned somewhat spaced apart from the clamping spring arrangement 4, as shown in FIG. 1a, in the completely open position.

The clamping spring arrangement 4 may be held—for example using an ancillary spring (not shown here)—in the opening position of FIG. 2, or the conductor end 3 of said arrangement may be moved into said position when the rotary lever arrangement 5 is rotated into the opening position thereof, in which the cam section 502 is rotated upwards (away from the busbar section 6).

In the position of FIG. 1a, the rotary lever arrangement 5 thus releases the clamping spring arrangement 4, in such a way that it can be pivoted around, by a tool or the conductor, in a direction of rotation “−DR”, to the left in FIG. 2a or 3a or to the right in the right connection device in FIG. 1a. As a result, a conductor end 3 can be inserted into the corresponding connection device—on the right in FIG. 1a or on the left in FIG. 2a.

To establish the contact position, the rotary lever arrangement 5 is now rotated in a direction of rotation “DR” counter to the direction of rotation “−DR”, in such a way that the control curve 503 of the cam section 502 comes to bear against the clamping spring arrangement 4 (FIG. 2b). Upon further rotation in the direction of rotation DR (FIG. 1d, 1d, 2b,c, 3b,c), the cam section 501 acts like a rotary lever—in the present case like an increasingly long rotary lever—on the actuating limb or limbs 411, 412. In the present case, it acts on the outer actuating limb 411 and presses it downwards in the −Z-direction (in other words, in the present case, downwards in the direction of the carrier rail). As a result, the entire clamping spring arrangement 4 is rotated in a direction of rotation DR identical to the direction of rotation DR. This presses the clamping limb or limbs 410 harder and harder against the conductor end 3—or tangentially to the clamping edge—and presses said end against the associated busbar section 6.

It is particularly advantageous that, as a result of the identical directions of rotation, the effective lever arm, by means of which the cam section acts on the actuating limb 411, 421 in the region of the control curve of said section, becomes larger and larger during the movement from the opening position into the contact position. This is particularly advantageous because the actuating force can be kept relatively low as a result. This is apparent in particular from a comparison of FIG. 1b to if—right side of the series terminal shown. These drawings show that the point or region at which the cam section 501 touches the clamping spring arrangement 4 in each case migrates radially further outwards on the cam section 501 from picture to picture with increasing closing or pressing of the clamping spring arrangement 4 against the conductor. In the present case, this takes place until the pin 504 in the radially outermost region of the cam section 501 is reached.

In FIG. 1, the end contact position has been reached in FIG. 1f. In this position, the actuating limbs 411, 421 and/or the rotary lever arrangement 5 can additionally be fixed in a positive and/or non-positive fit, for example on the busbar section 6 or on another element, in such a way that a particularly stable end contact position is implemented, which is not released even under relatively high stresses.

The advantages described in the above paragraphs were not recognised, or insufficiently recognised, in the prior art, since therein the focus was on other, less important points in the structural implementation. The invention deviates from this, and instead focuses on reliably achieving uniform wiring movement and unwiring movement and achieving a high contact force in the end contact position. In the following, further structural variants are described by way of which the invention can be further optimised.

Thus, the actuating limb or limbs 411, 421 may be formed elbowed at the free ends thereof so as to ensure good sliding of the control curve on the actuating limb or limbs 411, 421. When the end contact position is reached, the clamping limb or limbs 410, 420 press on the conductor end (FIG. 1d, e), preferably until the clamping spring arrangement 4 and/or the rotary lever arrangement 5 are fixed on a thrust bearing in a positive and/or non-positive fit.

Preferably, for this purpose it is provided that a latching means, for example the aforementioned pin 504, is formed on the cam section 502, and is movable into a fixing position in the slotted link 18. Particularly preferably, this fixing position is formed in the busbar. For this purpose, it may advantageously be provided that the slotted link 18, in the housing, transitions into a corresponding slotted link 60 in the associated busbar section 6, or rather ends in this section, before the latching position is reached. In this case, the slotted link 60 may have, in the associated busbar section, a constriction point 61 or a top-dead-centre point in which the pin 504 is fixed securely in place, in particular latched, when the end contact position is reached. This can be seen particularly clearly in FIG. 1g. The slotted link 18 is aligned with the slotted link 60. Specifically for releasing the end contact position, it is merely necessary to move the pin from the latching position behind the constriction 61 of the slotted link 60 in the busbar by rotating the rotary lever arrangement 5.

It is particularly advantageous if the end contact position is durably securely fixed on the metal busbar 6 and not in the plastics material housing 1. In this case, attaching a pin 504 to the cam section and forming the latching position in the slotted link 60 of the busbar section 6 provides a particularly simple variant for fixing the spring arrangement in the end contact position, which also results in simple, uniform operability when establishing and releasing the contact position. It is also advantageous in particular that, for release from the end contact position, no latching hook or the like on the spring arrangement has to be released from a locking position.

FIG. 4) additionally illustrates, in an exploded view, the design of a series terminal in the manner of FIG. The disc-like design of the housing 1 in a stackable configuration can clearly be seen. In addition, it can clearly be seen here that the disc-like housing 1 may be constructed in a plurality of parts. The housing 1 may for example be composed of two half-shells 101 and 102, as shown. In one or both of the half-shells 101, 102, the slotted link 18 may be formed, which in the present case is aligned, at one end thereof, with the slotted link 60 in the associated busbar section 6 in each case. The other half-shell is formed as a rear wall in the present case.

The spring carrier 45 may be formed in a single piece with the housing 1 or as a separate part from the housing. If it is formed separately from the housing 1, it is advantageous for the clamping spring arrangement 4 to be capable of being preassembled on the spring carrier 45 and for the preassembled unit subsequently to be separately insertable into the housing 1 and fixable therein, in particular by clamping and/or latching. The spring carrier 45 may itself, in turn, be formed in a single piece or multiple pieces. It may also consist of two halves which are folded together when the clamping springs and/or release springs are mounted.

The spring carrier 45 may also be arranged pivotably in the housing. In this case said carrier may even—if the actuating limb is arranged rotationally engaged thereon—join in with the functionality of this actuating limb 410 in whole or in part. This functionality is shown in FIG. 3. In this case, said carrier forms part of the clamping spring arrangement 4 within the meaning of the claims.

The clamping springs 41, 42 of the leaf spring arrangement are preferably arranged inside one another in a stack-like manner. This means that the bending regions 412, 422 thereof are positioned inside one another and have exactly or substantially the same axis of rotation D1 or D1′. In this case, the support contour has a rounded journal section 451 about which the clamping springs 41, 42 can be rotated in the bending regions 411, 412 thereof. In this case, the spring carrier 45 serves, in the manner of a bolt, in the region in which the bending region 412, 422 is positioned against it, as a pivot bearing for the clamping spring arrangement or for the one or more individual springs or clamping springs of the clamping spring arrangement 4.

The restoring spring 43 is likewise formed as a V-shaped leaf spring. This has been moved into a compressed position in the end contact position. Here, it is positioned internally with respect to the two clamping springs 41 and 42. If the rotary lever arrangement 5 is released from the fixing position thereof, or in the present case the latching position of the contact position (corresponding to FIG. 1c, left side), and rotated back into the unwired opening position, the restoring spring 43, which is braced by a support limb against the spring recess (see FIG. 1), relaxes. In this way, the restoring spring 43 presses against the actuating limbs 411, 412 of the two clamping springs 41, 42 from the inside, and the clamping spring arrangement 4 as a whole also rotates back into the opening position again. In the present case, this restoring functionality has thus been implemented in a functionally reliable manner in a small installation space using simple means.

In FIG. 3, it is provided that the spring carrier 45 is arranged pivotably in the housing 1. Since in the present case the actuating limb 411 or 412 is arranged rotationally engaged on said carrier, it thus joins in with the functionality of this actuating limb 411 in whole or in part. This functionality is shown in FIG. 3. In the present case, over part of the rotational movement, the cam section 502 acts on the spring carrier 45 or on an arm 452 of the spring carrier, and additionally rotates the contact spring(s). The clamping limb or limbs project beyond the spring carrier 45, and the ends thereof are free, and they still function as clamping spring limbs. In the present case, the spring carrier 45 thus also forms part of the clamping spring arrangement 4. The springs 41, 42, 43 are in turn preassembled on the spring carrier—preferably again at slots 453, 454—which thus in turn forms a unit which is preassembled as a whole and which can be mounted as a whole on the busbar 6 or directly in the clamping housing (FIG. 7a-7d).

### LIST OF REFERENCE NUMERALS

| | |
|---|---|
| Housing | 1 |
| Connection devices | 2 |
| Conductor end | 3 |
| Clamping spring arrangement | 4 |
| Rotary lever arrangement | 5 |
| Busbar section | 6 |
| Affixing foot | 11 |
| Upper face | 12 |
| Plug-in faces | 13, 14 |
| Rotary receiving contour | 15 |
| Opening | 16 |
| Insertion opening | 17 |
| Slotted link | 18 |
| Half-shells | 101, 102 |
| Leaf springs | 41, 42 |
| Clamping limbs | 410, 420 |
| Actuating limbs | 411, 421 |
| Bending region | 412, 422 |
| Spring carrier | 45 |
| Journal section | 451 |
| Spring carrier arm | 452 |
| Slot | 453, 454 |
| Rotary lever element | 50 |
| Section | 500 |
| Actuating section | 501 |
| Section | 502 |
| Control curve | 503 |
| Pin | 504 |
| Slotted link | 60 |
| Constriction point | 61 |
| Slot | 62 |
| Axis of rotation | D1 or D1′ |

1. Connection device for the connection of a conductor end (3), which connection device has a housing (1) and also a busbar section (6), a clamping spring arrangement (4) and a rotary lever (5) arrangement in the housing (1), the clamping spring arrangement (4) being able to be rotated, with the aid of the rotary lever arrangement (5), from an open position to a contact position, in which contact is made with the conductor end (3), the clamping spring arrangement consisting of one or more clamping springs (41, 42) which are each embodied as leaf springs and each have at least one clamping limb (410, 420) and at least one actuating limb (411, 421), characterised in that the at least one clamping limb (410, 420) and the at least one actuating limb (411, 421) are oriented at an angle, preferably at an acute angle of between 5° and 85°, in relation to one another and are connected to one another by means of a bending region (412, 422), the bending region (412, 422) of at least one of the leaf springs (41, 42) bearing against a spring carrier (45), the spring carrier (45) being designed as a part which is preferably separate from the housing (1), and the clamping spring arrangement (4) being capable of being preassembled on the spring carrier (45).

2. Connection device according to claim 1, characterised in that the rotary lever arrangement (5) has a rotary lever element (50) which is mounted rotatably in the housing (1) in or on a preferably central section (500) and which has the axis of rotation (D2).

3. Connection device according to either of the preceding claims, characterised in that the axis of rotation D1 of the clamping spring arrangement (4) and sections of the clamping spring arrangement (4) are arranged above the conductor end (3) to be contacted and above the associated busbar section (6), and in that the rotary lever arrangement (5) has an axis of rotation D2 which is positioned above the axis of rotation D1 of the clamping spring arrangement (4).

4. Connection device according to any of the preceding claims, characterised in that the clamping spring arrangement (4) is capable of being preassembled on the spring carrier (45), and in that this preassembled unit is insertable into the housing (1) individually and separately or together with another element, in particular together with the busbar section (6).

5. Connection device according to any of the preceding claims, characterised in that the preassembled unit can be fixed in the housing or on the associated busbar section (6), for example in a positive and/or non-positive fit, in particular by clamping and/or latching.

6. Connection device according to any of the preceding claims, characterised in that the spring carrier (45) is arranged pivotably in the housing.

7. Connection device according to any of the preceding claims, characterised in that the spring carrier (45) has one or more mounting means, in particular one or more slots, for mounting the one or more clamping springs (41, 42).

8. Connection device according to any of the preceding claims, characterised in that the spring carrier (45) further has one or more mounting means, in particular a further slot, for mounting a restoring spring (43).

9. Connection device according to any of the preceding claims, characterised in that the restoring spring (43) is formed as a further leaf spring.

10. Connection device according to any of the preceding claims, characterised in that the cam section (502) acts on the spring carrier (45) and rotates it together with the clamping spring arrangement (4).

11. Connection device according to any of the preceding claims, characterised in that the clamping springs (41, 42) are arranged laid inside one another in such a way that the bending regions (412, 422) thereof are positioned inside one another and have exactly or substantially the same axis of rotation D1 or D1′.

12. Connection device according to any of the preceding claims, characterised in that the actuating limbs (411, 421) and/or the clamping limbs (410, 420) of the leaf springs (41, 42) are of different lengths.

13. Connection device according to any of the preceding claims, characterised in that the spring carrier (45) has a rounded journal section (451), about which the clamping springs (41, 42) can be rotated in the bending regions (411, 412) thereof.

14. Connection device according to any of the preceding claims, characterised in that the rotary lever element (50) has a cam section (502), which has a control curve (503) on which the actuating limb or limbs of the clamping springs slide along during a movement into the end contact position, and in that a means of the cam section (502), such as a projection or such as a pin (504) or the like inserted into said section, engages in a slotted link (18) of the housing (1), and in that a clamping and/or latching means is formed on the cam section (502) and is movable in the slotted link (18) into a fixing position, the fixing position being formed in the busbar section (6).

15. Connection device according to any of the preceding claims, characterised in that the clamping and/or latching means is the pin (504), which is movable in the slotted link (18) into a fixing position.

16. Connection device according to any of the preceding claims, characterised in that, in the housing (1), before the latching position is reached, the slotted link (18) transitions into a corresponding slotted link (60) in the associated busbar section (6) or rather ends in this section, and in that this slotted link (60) has a point, in particular a constriction point or a top-dead-centre point, at which the pin (504) is fixed securely in position when the end contact position is reached, in such a way that the end contact position is durably securely fixed at the metal busbar section (6).

17. Connection device according to any of the preceding claims, characterised in that, when the end contact position is reached, the clamping limb or limbs (410, 421) press on the conductor end (39), the clamping spring arrangement (4) and/or the rotary lever arrangement (5) additionally preferably being locked on a thrust bearing in a positive and/or non-positive fit by means of a locking device.

18. Connection device according to any of the preceding claims, characterised in that the effective lever arm, by means of which the cam section acts on the actuating limb (411, 421) in the region of the control curve of said section, becomes larger during the movement into the contact position.

19. Connection device according to any of the preceding claims, characterised in that, in the end contact position, the clamping spring arrangement (4) and/or the rotary lever arrangement (5) are additionally fixed in a positive and/or non-positive fit, for example on the busbar section (6) or on another element.

20. Connection device according to any of the preceding claims, characterised in that the rotary lever element (50) has an actuating section (501).

21. Connection device according to any of the preceding claims, characterised in that the rotary lever arrangement (5) and the clamping spring arrangement (4) have the same direction of rotation (DR) during the rotation from the open position into the contact position

22. Connection device according to any of the preceding claims, characterised in that the busbar section (6) is configured trough-shaped, in particular V- or U-shaped, in cross section, the conductor end (3) being insertable into the busbar section (6) perpendicular to this cross section, and in that the clamping spring arrangement (4) is designed to be pivoted, at least in sections, into the busbar section (6) transverse to the conductor insertion direction so as to press the conductor end (3) in the end contact position into the trough-shaped busbar section (6) so as to contact said section in this region.

23. Connection device according to any of the preceding claims, characterised in that the actuating limb or limbs (411, 421) are formed elbowed at the free ends thereof so as to slide on the control curve (503).
